(19) United States
(12) Patent Application Publication
(10) Pub. No.: US 2026/0316666 A1
(43) Pub. Date: Oct. 15, 2026

(54) METHOD OF CONTROLLING HEAD LAMP BASED ON OBJECT TRACKING AND APPARATUS THEREOF

(71) Applicant: HYUNDAI MOBIS CO., LTD., Seoul (KR)

(72) Inventor: Myeong Je KIM, Yongin-si (KR)

(73) Assignee: HYUNDAI MOBIS CO., LTD., Seoul (KR)

(21) Appl. No.: 19/438,178

(22) Filed: Dec. 31, 2025

(30) Foreign Application Priority Data
Apr. 11, 2025 (KR) 10-2025-0047552

(51) Int. Cl. B60Q 1/14; G06T 7/246; G06T 7/277; G06V 20/58

(52) U.S. Cl. CPC B60Q 1/143; G06T 7/246; G06T 7/277; B60Q 2300/054; B60Q 2300/41; G06T 2207/10028; G06T 2207/30252; G06V 20/58

(57) ABSTRACT

Provided are a method which controls a head lamp and an apparatus thereof. The method includes detecting a forward vehicle by using at least one sensor provided in a host vehicle, assigning a unique identifier (ID) to the forward vehicle, tracking a position of the forward vehicle based on the unique ID, generating a shadow zone for the forward vehicle based on the tracked position of the forward vehicle, and controlling illumination of the head lamp to form the generated shadow zone for the forward vehicle.

### CROSS-REFERENCE TO RELATED APPLICATION

This application claims priority to and the benefit of Korean Patent Application No. 10-2025-0047552, filed in the Korean Intellectual Property Office on Apr. 11, 2025, the entire contents of which are incorporated herein by reference for all purposes.

### TECHNICAL FIELD

The present disclosure relates to a technology for controlling a head lamp, and more particularly, to a method for controlling a head lamp based on object tracking, which is capable of controlling the head lamp, for example, a high-resolution adaptive driving beam (ADB), based on object tracking to form a shadow zone in units of objects.

### BACKGROUND

The high-resolution LED market has gradually expanded, and accordingly, convenience and safety have been improved through precise control of an adaptive driving beam (ADB).

As the number of pixels in an LED increases, a shadow zone may be made smaller for each vehicle when controlling ADB. However, when the shadow zone is made smaller, the position of an opposing vehicle may be incorrectly estimated due to misrecognition by a sensor, which may cause glare.

That is, while high-resolution ADB is controlled, when the shadow zone is large, it does not have a significant effect even though an error occurs in the sensor, but when the shadow zone is small, precise control is required accordingly.

### SUMMARY

The present disclosure has been made to solve the above-mentioned problems occurring in the prior art while advantages achieved by the prior art are maintained intact.

One aspect of the present disclosure provides a method and apparatus for controlling a head lamp based on object tracking, which are capable of controlling the head lamp, for example, a high-resolution ADB, based on object tracking such that an object-level shadow zone is formed.

Another aspect of the present disclosure provides a method and apparatus for controlling a head lamp based on object tracking, which are capable of accurately forming a shadow zone for at least one forward vehicle through control of a high-resolution ADB.

The technical problems to be solved by the present disclosure are not limited to the aforementioned problems, and any other technical problems not mentioned herein will be clearly understood from the following description by those skilled in the art to which the present disclosure pertains.

According to one aspect of the present disclosure, a method of controlling a head lamp of a host vehicle includes detecting a forward vehicle by using at least one sensor provided in the host vehicle; assigning a unique identifier (ID) to the forward vehicle; tracking a position of the forward vehicle based on the unique ID; generating a shadow zone for the forward vehicle based on the tracked position of the forward vehicle; and controlling illumination of the head lamp to form the generated shadow zone, thereby reducing glare for the at least one forward vehicle.

In some embodiments, the generating of the shadow zone may include generating the shadow zone for the forward vehicle by applying a Kalman filter to the tracked position of the forward vehicle.

In some embodiments, the detecting may include detecting two or more forwarding vehicles; and the generating of the shadow zone includes, in response to determining that shadow zones for the two or more forward vehicles overlap at or above a preset overlap ratio, integrally generating a single combined shadow zone that encompasses the two or more forward vehicles.

In some embodiments, the method may further include expanding the single combined shadow zone by a predetermined margin.

In some embodiments, the generating of the shadow zone may include generating a shadow zone for each forward vehicle by using multiple sensors including a camera and a Lidar when two or more forward vehicles are detected and overlap.

In some embodiments, the head lamp may include an adaptive driving beam (ADB).

In some embodiments, a non-transitory computer-readable medium may be provided to store instructions that, when executed by a processor, cause a computing system to perform the method described herein.

According to one aspect of the present disclosure, a method of controlling a head lamp of a host vehicle includes detecting a forward vehicle by using at least one sensor provided in the host vehicle; assigning a unique ID to the forward vehicle; tracking location information of the unique ID over a series of time frames to generate tracking information; generating a shadow zone for the forward vehicle based on the tracking information; and controlling illumination of the head lamp to form the shadow zone for the forward vehicle.

In some embodiments, the generating of the shadow zone may include applying a Kalman filter to the tracking information.

According to one aspect of the present disclosure, an apparatus for controlling a vehicle head lamp includes a detection device configured to detect a forward vehicle using at least one sensor; a tracking device, operatively coupled to the detection device, configured to assign a unique identifier (ID) to the forward vehicle, and track a position of the forward vehicle over time based on the unique ID; a generation device, operatively coupled to the tracking device, configured to generate a shadow zone for the forward vehicle based on the tracked position of the forward vehicle to generate tracking information; and a controller, operatively coupled to the generation device and the headlamp, and configured to control illumination of the head lamp to form the generated shadow zone.

In some embodiments, the generation device may be configured to generate the shadow zone for the forward vehicle by applying a Kalman filter to the tracking information of the forward vehicle.

In some embodiments, the generation device may be configured to, in response to a determination that two or more forward vehicles have overlapping shadow zones at or above a preset overlap ratio, integrally generate a single combined shadow zone that encompasses the two or more forward vehicles.

In some embodiments, the generation device may be further configured to expand the single combined shadow zone by a predetermined margin.

In some embodiments, the generation device may be configured to generate a shadow zone for each forward vehicle based on the tracking information by using multiple sensors including a camera and a Lidar when two or more forward vehicles are detected and overlap.

In some embodiments, the controller may be configured to generate a control signal to form the shadow zone for the forward vehicle and provide the control signal to the head lamp, and wherein the head lamp may include a driving device configured to individually control on/off states of light pixels of the head lamp based on the control signal.

The features briefly summarized above with respect to the present disclosure are merely exemplary aspects of the detailed description of the present disclosure described below and do not limit the scope of the present disclosure.

### BRIEF DESCRIPTION OF THE DRAWINGS

The above and other objects, features and advantages of the present disclosure will be more apparent from the following detailed description taken in conjunction with the accompanying drawings:

FIG. 1 is a flowchart illustrating a method of controlling a head lamp according to an embodiment of the present disclosure;

FIG. 2A and FIG. 2B is a diagram illustrating a process of tracking the position of a forward vehicle and generating a shadow zone;

FIG. 3A and FIG. 3B is a diagram illustrating a process of generating a shadow zone when multiple forward vehicles overlap;

FIG. 4A and FIG. 4B is a diagram illustrating a process of generating a shadow zone for each forward vehicle by using multiple sensors;

FIG. 5 is a block diagram illustrating a configuration of an apparatus for controlling a head lamp according to another embodiment of the present disclosure; and

FIG. 6 is a block diagram illustrating a computing system for executing a method of controlling a head lamp according to an embodiment of the present disclosure.

### DETAILED DESCRIPTION

Hereinafter, various embodiments of the inventive concept will be described in detail with reference to the accompanying drawings, so that those skilled in the art can easily carry out the inventive concept. However, the inventive concept is not limited to the embodiments set forth herein and may be modified variously in many different forms.

In describing the embodiments of the present specification, when a specific description of the related art is deemed to obscure the subject matter of the embodiments of the present specification, the detailed description will be omitted. In the drawings, the portions irrelevant to the description will not be shown in order to make the present disclosure clear.

It will be understood that when an element is referred to as being “connected” or “coupled” to another element, it may be directly connected or indirectly connected to another element. In addition, when some part ‘includes’ or “has” some elements, unless explicitly described to the contrary, it means that other elements may be further included but not excluded.

Expressions such as “first,” or “second,” and the like, may express their elements regardless of their priority or importance and may be used to distinguish one element from another element but is not limited to these components. Therefore, without departing from the scope of the present disclosure, a first component of one embodiment may be referred to as a second component of another embodiment. Similarly, a second component of one embodiment may be referred to as a first component of another embodiment.

In the present disclosure, components that are distinguished from each other are only for clearly describing characteristics, and do not mean that the components are necessarily separated. That is, a plurality of components may be integrated to form a single hardware or software unit, or a single component may be distributed to form a plurality of hardware or software units. Accordingly, such integrated or distributed embodiments are included in the scope of the present disclosure, even though not mentioned separately.

In the present disclosure, components described in various embodiments do not necessarily mean essential components, and some may be optional components. Therefore, an embodiment composed of a subset of components described in an embodiment is also included in the scope of the present disclosure. In addition, embodiments including other components in addition to the components described in various embodiments are also included in the scope of the present disclosure.

In the present disclosure, expressions of positional relationships used herein, such as upper, lower, left, right and the like, are described for convenience of description. When viewing the drawings shown in this specification in reverse, the positional relationship described in the specification may be interpreted in the opposite manner.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

Embodiments of the present disclosure are directed to controlling the illumination of a high-resolution head lamp, for example, a head lamp including a light source of 1,000 pixels or more, such that a shadow zone of a forward vehicle is accurately formed when the forward vehicle located in front of a host vehicle (e.g., an opposing vehicle traveling in the opposite direction and the forward vehicle traveling in the same direction) is detected.

The head lamp in the embodiments of the present disclosure may include an adaptive driving beam (ADB), and may also include any type of head lamp capable of controlling the on/off of each pixel.

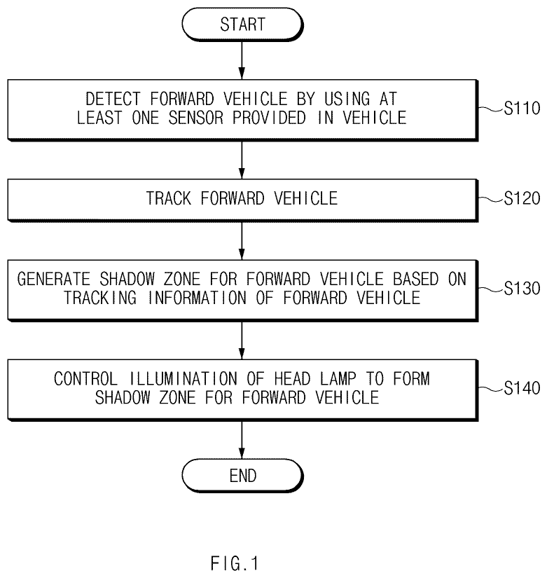

FIG. 1 is a flowchart illustrating a method of controlling a head lamp according to an embodiment of the present disclosure.

Referring to FIG. 1, in operation S110, a method of controlling a head lamp according to an embodiment of the present disclosure detects a forward vehicle located in front of a host vehicle by using at least one sensor provided in a vehicle, such as a camera, a distance detection sensor, a Lidar, and the like.

According to an embodiment, in operation S110, a forward vehicle may be detected based on an image captured in real time by a camera, or may be detected by using a pre-learned object classification model or vehicle detection model having an image captured in real time by a camera as input. Depending on the situation, in operation S110, it is possible to detect a forward vehicle by reflecting information detected by a distance detection sensor and Lidar as well as a camera.

In operation S120, each forward vehicle detected through real-time detection in operation S110 is tracked. That is, in operation S120, tracking information for the detected forward vehicle may be generated.

According to an embodiment, in operation S120, a unique ID (or object ID) may be assigned to the detected forward vehicle, and each forward vehicle may be tracked in real time through location tracking for the assigned unique ID.

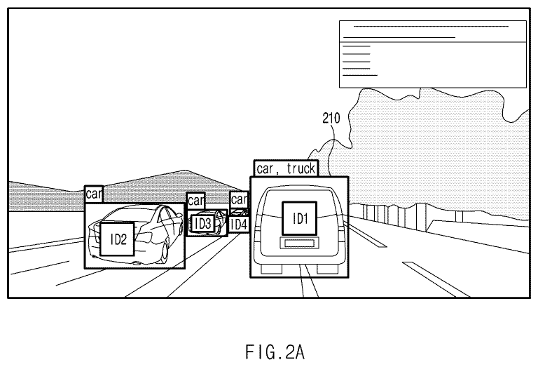

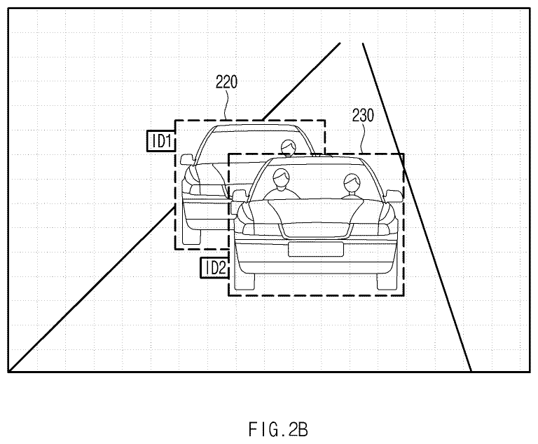

For example, in operation S120, ID1 210, ID2, ID3, ID4, and the like may be assigned to detected forward vehicles, respectively as illustrated in FIG. 2A, and location information for ID1 210, ID2, ID3, and ID4 assigned to each forward vehicle may be tracked in real time, thereby tracking each forward vehicle.

In this case, by updating the location information for ID1 210, ID2, ID3, and ID4 with the location information input in units of frames based on each ID, the location of each forward vehicle may be tracked, and in operation S120, the location of each forward vehicle may be tracked by updating the location information of each of ID1, ID2, ID3, and ID4 as shown in Table 1 below.

TABLE 1

| ID | Position t1 | Position t2 | Position t3 |
|---|---|---|---|
| 1 | (X₁, Y₁) | (X₂, Y₂) | (X₃, Y₃) |
| 2 | (X₁, Y₁) | (X₁, Y₁) | (X₁, Y₁) |
| 3 | (X₁, Y₁) | (X₁, Y₁) | (X₁, Y₁) |
| 4 | (X₁, Y₁) | (X₁, Y₁) | (X₁, Y₁) |

According to an embodiment, in operation S120, each forward vehicle may be tracked by using various information about the forward vehicle as well as location information for each ID.

For example, in operation S120, each forward vehicle may be tracked by using various information about each ID as shown in Table 2 below.

TABLE 2

| Signal name | Purpose of use |
|---|---|
| Unique ID | Position tracking of opposite vehicle |
| | by object unit |
| Object relative lateral position | Object X position recognition |
| Object relative longitudinal | Object Y position recognition |
| position | |
| Object width | Object width recognition |
| Object-relative lateral velocity | Object lateral motion recognition |
| Object relative longitudinal | Object longitudinal motion recognition |
| velocity | |
| Object type | Vehicle height recognition for passenger |
| | car, motorcycle, truck, bus, etc. |
| Object undetected count | Data loss recognition |

As illustrated in Table 2, information for tracking a forward vehicle may include a unique ID of the forward vehicle, an object relative lateral position and an object relative longitudinal position corresponding to location information, an object width for recognizing an object width, object relative lateral and longitudinal speeds for recognizing object lateral and longitudinal movements, an object type for recognizing a height of a vehicle such as a passenger car, motorcycle, truck, bus, or the like, and an object non-detection count item for recognizing data loss. Of course, in addition to the data items described above, it may also include various other items for tracking each forward vehicle in real time.

When the forward vehicle is tracked in real time in operation S120, in operation S130, a shadow zone for the forward vehicle is generated based on the tracking information of the forward vehicle tracked in real time.

For example, in operation S130, shadow zones 220 and 230 for ID1 and ID2 may be generated based on object tracking information for ID1 and ID2, which are unique IDs of the forward vehicles, as illustrated in FIG. 2B.

According to an embodiment, in operation S130, a reliable shadow zone location may be generated by applying a filter to the location information input for each ID because the vehicle location may be incorrectly identified due to misrecognition of the sensor during location tracking by object ID.

In this case, in operation S130, a reliable shadow zone for the forward vehicle may be generated by applying a Kalman filter that is able to estimate an optimal state from data containing noise (e.g., when sensor data is incomplete or measurement values contain noise, or the like).

That is, in operation S130, the Kalman filter may be applied to correct the estimates to be similar to the true values even though the measurements from the sensor differ from the true values due to ambient noise, thereby accurately generating a shadow zone for the forward vehicle even when the tracking information includes noise, and the like.

Furthermore, there may be two or more forward vehicles and the two or more forward vehicles overlap each other. In this case, even with only minute location information of the two forward vehicles (or objects) in the overlapping section, frequent head lamp light sources (e.g., LED) may turn on/off, which may cause driver fatigue.

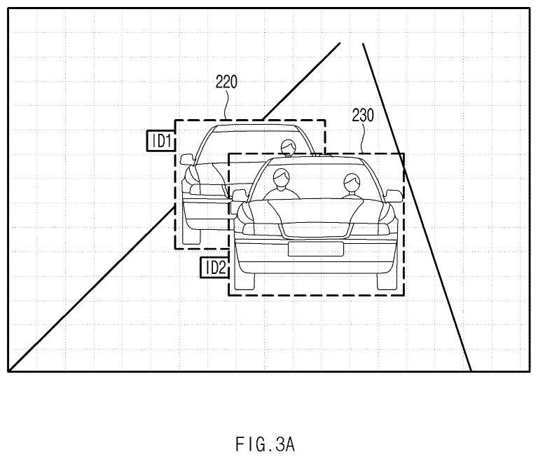

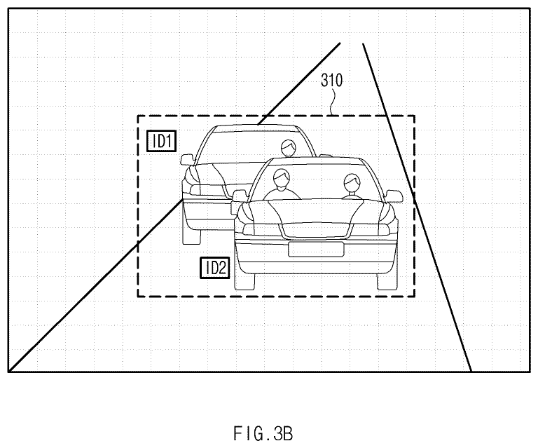

In order to prevent frequent LED turning on/off that may be caused by overlapping of two or more forward vehicles, in operation S130, when there are two or more forward vehicles and the shadow zones 220 and 230 of the two or more forward vehicles overlap (or when the forward vehicles overlap) as shown in FIG. 3A, a single shadow zone 310 for the two or more forward vehicles may be generated by integrating the shadow zones for the two or more forward vehicles as shown in FIG. 3B.

In this case, in operation S130, the single shadow zone 310 may be generated by integrating the shadow zones for two or more forward vehicles when the two or more forward vehicles overlap at a preset overlap ratio or higher, and the integrated shadow zone may be expanded by considering a preset specific margin. Of course, the specific margin may be determined by considering a degree of overlap, a vehicle type, a vehicle size, a distance from the vehicle, and the like.

Furthermore, in operation S130, a single integrated shadow zone may be generated until the overlapping rate of two or more forward vehicles is less than a preset overlapping rate, and a shadow zone for each forward vehicle may be generated when the overlapping rate of two or more forward vehicles is less than the preset overlapping rate.

The overlapping ratio of a forward vehicle may be calculated as the ratio of the area where the shadow zone 220 of ID1 and the shadow zone 230 of ID2 overlap as shown in FIG. 3A and the total shadow zone area of the shadow zone 220 of ID1 and the shadow zone 230 of ID2.

In addition, when two or more forward vehicles overlap and the shadow zone locations overlap, the accuracy of the vehicle position measured by the sensor may decrease due to interference between the forward vehicles in the overlapping section.

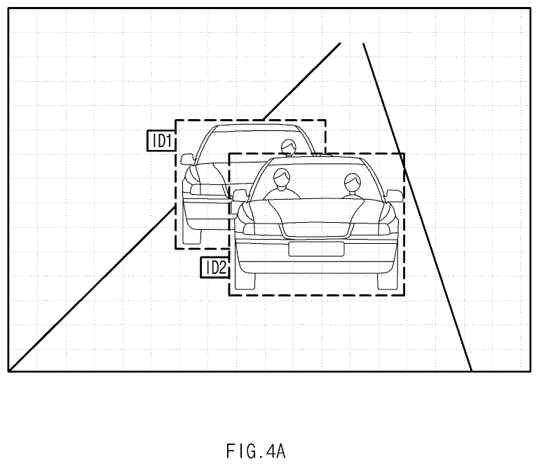

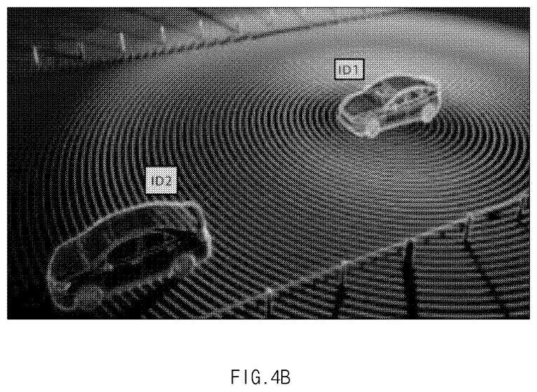

According to an embodiment, in operation S130, in order to improve the vehicle position accuracy that may occur in the overlapping section, a shadow zone for each forward vehicle may be generated by reflecting information on ID1 and ID2 by other sensors, such as Lidar, as shown in FIG. 4B, to the location tracking of ID1 and ID2 by a camera as shown in FIG. 4A. That is, in operation S130, shadow zones for forward vehicles or a single integrated shadow zone may be generated based on tracking information obtained by using multiple sensors including a camera and Lidar when two or more forward vehicles are detected and overlap.

When the shadow zone for a forward vehicle is generated in operation S130, in operation S140, a control signal for the shadow zone is transmitted to the head lamp to control the on/off of each pixel (or light source) constituting the head lamp such that the shadow zone for the forward vehicle is generated, thereby controlling the illumination of the head lamp.

According to an embodiment, in operation S140, a driving device constituting the head lamp may receive a control signal for the shadow zone and control the on/off of each LED based on the control signal, thereby controlling the irradiation of light sources constituting the head lamp so that a shadow zone of each forward vehicle is formed.

As described above, a method of controlling a head lamp according to an embodiment of the present disclosure may control the head lamp, for example, a high-resolution ADB, based on object tracking such that a shadow zone is formed in units of objects (e.g., units of forward vehicles).

In addition, a method of controlling a head lamp according to an embodiment of the present disclosure may secure convenience and safety by accurately forming a shadow zone for at least one forward vehicle through control of a high-resolution ADB.

In addition, a method of controlling a head lamp according to an embodiment of the present disclosure may accurately form a shadow zone of a forward vehicle by improving the accuracy of tracking the location of each forward vehicle by using multiple sensors including a camera and Lidar when two or more forward vehicles overlap.

In addition, a method of controlling a head lamp according to an embodiment of the present disclosure may prevent frequent LED turning on/off by forming a single integrated shadow zone by considering the overlapping rate of two or more forward vehicles.

As described above, though a method of controlling a head lamp according to an embodiment of the present disclosure has been described as generating a shadow zone for a forward vehicle based on tracking information of the forward vehicle and controlling the illumination of a head lamp based on the same, the technology of the present disclosure is not limited or restricted to generating a shadow zone based on tracking information, and may receive location information of the forward vehicle and generate the shadow zone for the forward vehicle by using only the location information.

For example, a method of controlling a head lamp according to another embodiment of the present disclosure may detect a forward vehicle by using at least one sensor provided in a vehicle, assign a unique ID to the detected forward vehicle, generate a shadow zone for the forward vehicle based on location information of the unique ID, and control the illumination of the head lamp to form the shadow zone for the forward vehicle.

In this case, the method of the present disclosure may track the location information of the unique ID and generate the shadow zone for the forward vehicle based on the tracking information for the location information of the unique ID.

When comparing a method of the present disclosure with the related art, a conventional scheme recognizes a vehicle by using left/right light source information and uses a spot detection scheme that transmits only the location of a specific point in time, so there is a possibility of misrecognition due to light spread of the light source, or the like.

On the other hand, the method of the present disclosure allows a camera to transmit a unique ID based on a light source and an outer shape of a vehicle, and the camera transmits information with the same unique ID only in consecutive cases within the field of view. In addition, the head lamp may predict or track each unique ID based on the accumulated information of each unique ID.

That is, the method of the present disclosure may determine whether there is misrecognition of a camera sensor, accurately control the shadow zone based on the determination inside the head lamp rather than the camera sensor information, and process overlapping sections, and the like even when multiple unique IDs are transmitted.

As described above, according to the method of the present disclosure, it is possible to accurately predict or track the location information of a forward vehicle by considering at least one piece of sensor data and information determined inside a head lamp, thereby accurately controlling the shadow zone of the forward vehicle.

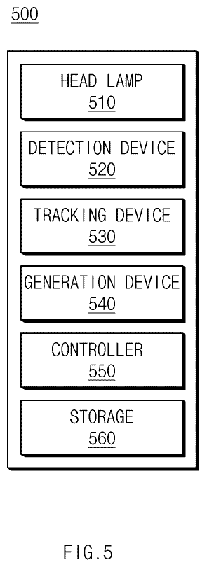

FIG. 5 is a block diagram illustrating a configuration of an apparatus for controlling a head lamp according to another embodiment of the present disclosure, and conceptually illustrates a configuration of an apparatus that performs the methods of FIGS. 1 to 4.

Referring to FIG. 5, an apparatus 500 for controlling a head lamp according to another embodiment of the present disclosure includes a head lamp 510, a detection device 520, a tracking device 530, a generation device 540, a controller 550, and storage 560.

The storage 560, which is a device for storing all data related to the technology of the present disclosure, may store front images captured in real time by a camera, tracking information for each forward vehicle analyzed from the front images, location tracking information, head lamp information, an algorithm for generating a shadow zone, a head lamp irradiation control algorithm, and the like. Of course, the storage 560 is not limited or restricted to the above-described data, and may store all data required to perform the technology of the present disclosure.

The head lamp 510 includes a light source having a specific number of pixels or more (e.g., 1000 pixels or more) and a driving device that controls the on/off of each light source (e.g., LED) based on a control signal received from a controller.

In this case, the head lamp 510 may be configured by separating the light source and the driving device or configured as a single integrated module, and may receive power from a device (e.g., a power supply) for supplying power to the head lamp 510.

According to an embodiment, the head lamp 510 may include a high-resolution adaptive driving beam (ADB).

The detection device 520 detects a forward vehicle located in front of a host vehicle by using at least one sensor provided in the vehicle, such as a camera, a distance detection sensor, a Lidar sensor, and the like.

According to an embodiment, the detection device 520 may detect a forward vehicle based on an image captured in real time by a camera, or may detect a forward vehicle by using a pre-learned object classification model or vehicle detection model having an image captured in real time by a camera as an input.

The tracking device 530 tracks each detected forward vehicle through real-time detection of the forward vehicle.

According to an embodiment, the tracking device 530 may assign a unique ID (or object ID) to each detected forward vehicle and track each forward vehicle in real time through location tracking for the assigned unique ID.

According to an embodiment, the tracking device 530 may track each forward vehicle by using various information about the forward vehicle, such as the example described in Table 2 above, as well as location information for each ID.

The generation device 540 generates a shadow zone for the forward vehicle based on the tracking information of each forward vehicle by the tracking device 530.

According to an embodiment, as the vehicle location may be incorrectly identified due to misrecognition of the sensor during location tracking by object ID, the generation device 540 may generate a reliable shadow zone location by applying a filter to the location information input for each ID.

In this case, the generation device 540 may generate a reliable shadow zone for the forward vehicle by applying a Kalman filter that estimates an optimal state from data containing noise (e.g., when sensor data is incomplete or measurement values contain noise, or the like).

Furthermore, there may be two or more forward vehicles which overlap each other. In this case, even with only minute location information of the two forward vehicles (or objects) in the overlapping section, the light sources (e.g., LED) of a head lamp may be frequently turned on and off, which may cause driver fatigue.

In order to prevent frequent LED turn on/off that may be caused by overlapping of two or more forward vehicles, the generation device may generate a single shadow zone by integrating shadow zones for two or more forward vehicles by integrating them into one shadow zone when there are two or more forward vehicles which overlap each other (or when shadow zones overlap).

In this case, the generation device 540 may generate a single shadow zone by integrating shadow zones for two or more forward vehicles when the two or more forward vehicles overlap at a preset overlap ratio or higher, and the single integrated shadow zone may be generated by being expanded by considering a preset specific margin. Of course, the specific margin may be determined by considering a degree of overlap, a vehicle type, a distance from the vehicle, or the like.

Furthermore, the generation device 540 may generate the single integrated shadow zone until the overlapping rate of two or more forward vehicles is less than the preset overlapping rate, and may generate a shadow zone for each forward vehicle when the overlapping rate of two or more forward vehicles is less than the preset overlapping rate.

In addition, when two or more forward vehicles overlap and the shadow positions overlap, the accuracy of the vehicle position measured by the sensor may decrease due to interference between the forward vehicles in the overlapping section.

According to an embodiment, in order to improve the vehicle position accuracy that may occur in the overlapping section, the generation device 540 may generate shadow zones for the forward vehicles or a single integrated shadow zone based on tracking information obtained by using multiple sensors including a camera and Lidar when two or more forward vehicles are detected and overlap.

The controller 550 controls the illumination of the head lamp by controlling the on/off of each pixel (or light source) constituting the head lamp by transmitting a control signal for the shadow zone to the head lamp, so that a shadow zone for the forward vehicle is generated.

According to an embodiment, the controller 550 may transmit a control signal for the shadow zone to the driving device of the head lamp, and control the on/off of each LED based on the control signal from the driving device, thereby controlling the irradiation of the light source constituting the head lamp to form the shadow zone of each forward vehicle.

In FIG. 5, the tracking device 530, the generation device 540 and the controller 550 are illustrated as separate components, but the tracking device 530, the generation device 540 and the controller 550 may be integrated into one control device, and depending on a situation, the tracking device 530 may be integrated into the detection device 520.

Although the description is omitted in an apparatus according to another embodiment of the present disclosure, the apparatus according to another embodiment of the present disclosure may include all contents described in the methods of FIGS. 1 to 4, which is obvious to those skilled in the art of the disclosure.

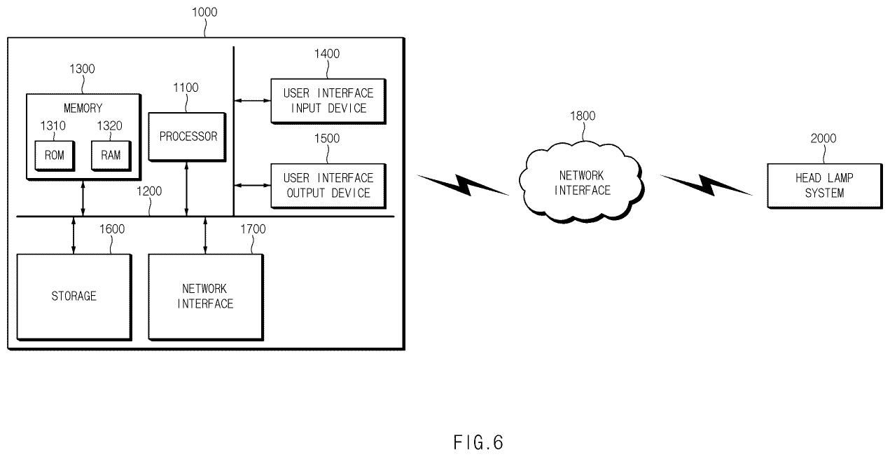

FIG. 6 is a block diagram illustrating a computing system for executing a method of controlling a head lamp according to an embodiment of the present disclosure.

Referring to FIG. 6, as described above, the method of controlling a head lamp according to an embodiment of the present disclosure may be implemented through a computing system. A computing system 1000 may include at least one processor 1100, a memory 1300, a user interface input device 1400, a user interface output device 1500, a storage 1600, and a network interface 1700, which are connected through a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to the present disclosure, the head lamp system 2000 and the computing system 1000 of FIG. 6 may be connected to each other through another network interface 1800 that is different from the network interface 1700. Here, the computing system 1000 and the head lamp system 2000 are not necessarily limited to being connected through the network interface 1800, and may be connected through at least one of wired communication, wireless communication, serial communication, parallel communication, in-vehicle communication networks (e.g., CAN, LIN, FlexRay), Ethernet-based communication, a dedicated interface, or any combination thereof. In addition, the computing system 1000 may include the head lamp system 2000, or, conversely, the head lamp system 2000 may be configured to include the computing system 1000.

According to the present disclosure, the head lamp system 2000 may include the head lamp 510 described with reference to FIG. 5, but is not necessarily limited thereto.

According to the present disclosure, a headlamp, for example, a high-resolution ADB may be controlled based on object tracking such that a shadow zone is formed in units of objects (e.g., units of forward vehicles).

According to the present disclosure, it is possible to secure convenience and safety by accurately forming a shadow zone for at least one forward vehicle through control of a high-resolution ADB.

According to the present disclosure, when two or more forward vehicles overlap, it is possible to improve the accuracy of tracking the location of each forward vehicle by using multiple sensors including a camera and Lidar, thereby accurately forming a shadow zone of the forward vehicle.

According to the present disclosure, it is possible to prevent frequent LED turning on/off by forming a single integrated shadow zone by considering the overlapping rate of two or more forward vehicles.

Effects obtained by various embodiments of the disclosure may not be limited to the above, and other effects will be clearly understandable to those having ordinary skill in the art from the following disclosures.

The above description is a simple exemplification of the technical spirit of the present disclosure, and the present disclosure may be variously corrected and modified by those skilled in the art to which the present disclosure pertains without departing from the essential features of the present disclosure. Therefore, the disclosed embodiments of the present disclosure do not limit the technical spirit of the present disclosure but are illustrative, and the scope of the technical spirit of the present disclosure is not limited by the embodiments of the present disclosure. The scope of the present disclosure should be construed by the claims, and it will be understood that all the technical spirits within the equivalent range fall within the scope of the present disclosure.

What is claimed is:

1. A method of controlling a head lamp of a host vehicle, the method comprising:
detecting a forward vehicle by using at least one sensor provided in the host vehicle;
assigning a unique identifier (ID) to the forward vehicle
tracking a position of the forward vehicle based on the unique ID;
generating a shadow zone for the forward vehicle based on the tracked position of the forward vehicle; and
controlling illumination of the head lamp to form the generated shadow zone, thereby reducing glare for the at least one forward vehicle.

2. The method of claim 1, wherein the generating of the shadow zone includes generating the shadow zone for the forward vehicle by applying a Kalman filter to the tracked position of the forward vehicle.

3. The method of claim 1, wherein the detecting includes detecting two or more forwarding vehicles; and the generating of the shadow zone includes, in response to determining that shadow zones for the two or more forward vehicles overlap at or above a preset overlap ratio, integrally generating a single combined shadow zone that encompasses the two or more forward vehicles.

4. The method of claim 3, further comprising expanding the single combined shadow zone by a predetermined margin.

5. The method of claim 1, wherein the generating of the shadow zone includes generating a shadow zone for each forward vehicle by using multiple sensors including a camera and a Lidar when two or more forward vehicles are detected and overlap.

6. The method of claim 1, wherein the head lamp includes an adaptive driving beam (ADB).

7. A non-transitory computer-readable medium storing instructions that, when executed by a processor, cause a computing system to perform the method of claim 1.

8. A method of controlling a head lamp of a host vehicle, the method comprising:
detecting a forward vehicle by using at least one sensor provided in the host vehicle;
assigning a unique ID to the forward vehicle;
tracking location information of the unique ID over a series of time frames to generate tracking information;
generating a shadow zone for the forward vehicle based on the tracking information; and
controlling illumination of the head lamp to form the shadow zone for the forward vehicle.

9. The method of claim 8, wherein the generating of the shadow zone comprises applying a Kalman filter to the tracking information.

10. An apparatus for controlling a vehicle head lamp, the apparatus comprising:
a detection device configured to detect a forward vehicle using at least one sensor;
a tracking device, operatively coupled to the detection device, configured to assign a unique identifier (ID) to the forward vehicle, and track a position of the forward vehicle over time based on the unique ID;
a generation device, operatively coupled to the tracking device, configured to generate a shadow zone for the forward vehicle based on the tracked position of the forward vehicle to generate tracking information; and
a controller, operatively coupled to the generation device and the headlamp, and configured to control illumination of the head lamp to form the generated shadow zone.

11. The apparatus of claim 10, wherein the generation device is configured to generate the shadow zone for the forward vehicle by applying a Kalman filter to the tracking information of the forward vehicle.

12. The apparatus of claim 10, wherein the generation device is configured to, in response to a determination that two or more forward vehicles have overlapping shadow zones at or above a preset overlap ratio, integrally generate a single combined shadow zone that encompasses the two or more forward vehicles.

13. The apparatus of claim 12, wherein the generation device is further configured to expand the single combined shadow zone by a predetermined margin.

14. The apparatus of claim 10, wherein the generation device is configured to generate a shadow zone for each forward vehicle based on the tracking information by using multiple sensors including a camera and a Lidar when two or more forward vehicles are detected and overlap.

15. The apparatus of claim 10, wherein the head lamp includes an adaptive driving beam (ADB).

16. The apparatus of claim 10, wherein the controller is configured to generate a control signal to form the shadow zone for the forward vehicle and provide the control signal to the head lamp, and
wherein the head lamp includes a driving device configured to individually control on/off states of light pixels of the head lamp based on the control signal.
